(19) United States
(12) Patent Application Publication
(10) Pub. No.: US 2021/0278943 A1
(43) Pub. Date: Sep. 9, 2021

(54) OPTICAL WORKSPACE LINK

(71) Applicant: Critical Systems, Inc., Boise, ID (US)

(72) Inventors: Theodore J. Jones, Boise, ID (US); James A. Pasker, Meridian, ID (US); Douglas Todd Kaltenecker, Boise, ID (US); Morgan Whitworth, Middleton, ID (US); Michael Troy Reese, Meridian, ID (US)

(73) Assignee: Critical Systems, Inc., Boise, ID (US)

(21) Appl. No.: 17/193,805

(22) Filed: Mar. 5, 2021

Related U.S. Application Data
(60) Provisional application No. 62/986,616, filed on Mar. 6, 2020.

(51) Int. Cl. G06F 3/0486; G06T 11/00; G06F 3/0484; G07C 3/08

(52) U.S. Cl. CPC G06F 3/0486; G07C 3/08; G06F 3/04842; G06T 11/00

(57) ABSTRACT

Embodiments described herein are directed to methods, systems, apparatuses, and user interfaces for remotely monitoring and controlling objects identified in images. In one scenario, a system is provided that includes an image sensing device configured to capture images, a transceiver, and an interactive interface that allows a user to select objects identified in at least one of the images captured by the image sensing device. Selecting an identified object within the images creates a corresponding node that provides data related to the identified object. The system also includes a data collection hub configured to receive and aggregate data received from the nodes created by the user through the interactive interface.

### CROSS-REFERENCE TO RELATED APPLICATIONS

This application claims priority to and the benefit of U.S. Provisional Application No. 62/986,616, entitled “Optical Workspace Link,” filed on Mar. 6, 2020, which application is incorporated by reference herein in its entirety.

### BACKGROUND

Industrial equipment and other manufacturing devices are typically designed to run around the clock with little downtime. Traditionally, this industrial equipment is monitored in a passive manner to ensure that it is operating normally. This passive monitoring includes placing sensors on industrial machines that are designed to trigger alerts when the machines operate abnormally. Many of these industrial machines, however, are legacy analog machines that have no built-in mechanism for communicating with outside systems. Accordingly, the machines may trigger local alarms, but workers must be nearby to respond to the alerts and adjust operation at the machines as needed.

### BRIEF SUMMARY

Embodiments described herein are directed to methods and apparatuses for identifying objects within images, establishing communications with those objects, and/or controlling the objects identified within the images. In one embodiment, a system is provided that includes an image sensing device configured to capture images. The system further includes a transceiver and an interactive interface that allows a user to select objects identified in the images captured by the image sensing device. When users select objects within the images, the system creates corresponding nodes that provide data related to the identified objects and, in some cases, allow those objects to be controlled. The system also includes a data collection hub that is configured to receive and aggregate data received from the nodes created by the user through the interactive interface.

In some cases, the interactive interface allows users to overlay configurable interactive patterns over the identified objects in the images. In some examples, the configurable interactive patterns may be dragged and dropped onto the identified objects, such that the configurable interactive patterns are overlaid on top of the identified objects.

In some embodiments, the configurable interactive patterns overlaid on top of the identified objects may allow users to receive data from the identified objects and transmit data to the identified objects. In some cases, the data transmitted to the identified objects may include control signals that control various aspects of the identified objects. In some examples, the data received from the identified objects includes a current status data for each of the identified objects.

In some embodiments, the configurable interactive patterns overlaid on top of the identified objects may allow real-time interaction with the identified objects. In some cases, the identified objects in the images may include electronic devices, pieces of machinery, pieces of equipment, people, sensors, or other objects. In some examples, the data received at the data collection hub may be presented in a control room monitoring device.

In some embodiments, the system's image sensing device may be positioned to capture a specific workspace. In such cases, the objects identified in the images of the workspace may include industrial equipment that is to be monitored. In some cases, the interactive interface may include various user interface display elements that display data related to the identified object. In some examples, the user interface display elements may be displayed on different computer systems that are remote from the workspace that is being monitored.

In some embodiments, a computer-implemented method is provided. The method may include capturing images using an image sensing device, instantiating an interactive interface that allows a user to select objects identified in at least one of the images captured by the image sensing device, and receiving user inputs that select an identified object within the images, where the selection creates a corresponding node that provides data related to the identified object. The method may further include instantiating a data collection hub configured to receive and aggregate data received from the nodes created by the user through the interactive interface.

In some cases, the data collection hub may be further configured to monitor for changes in state in equipment under surveillance by the image sensing device. In some embodiments, the method may also include generating alerts or notifications directed to specific individuals or entities upon determining that a specified change in state has occurred. In some examples, the aggregated data received from the nodes created by the user is further analyzed by various machine learning algorithms to identify when the identified object is functioning abnormally.

In some embodiments, different machine learning algorithms may be implemented to identify the objects in the images captured by the image sensing device. In some cases, the interactive interface may provide configurable interactive patterns that are overlaid on top of the identified objects in the images. In some examples, the configurable interactive patterns may allow users to issue commands to the identified objects. Those commands are then interpreted and carried out by the identified objects. In some cases, the issued commands may specify changes of state that are to be effected on the identified objects.

Some embodiments may provide a non-transitory computer-readable medium that includes computer-executable instructions which, when executed by at least one processor of a computing device, cause the computing device to: capture images using an image sensing device, instantiate an interactive interface that allows a user to select objects identified in at least one of the images captured by the image sensing device, and receive user inputs that select an identified object within the images. The selection then creates a corresponding node that provides data related to the identified object. The processor of the computing device may then instantiate a data collection hub that is configured to receive and aggregate data received from the nodes created by the user through the interactive interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computing environment in which one or more of the embodiments described herein may operate.

FIG. 2 illustrates a flowchart of an example method for identifying objects within images, establishing communications with those objects, and/or controlling the identified objects.

FIG. 3 illustrates an embodiment of a computing environment in which configurable interactive patterns are applied to identified objects within an image.

FIG. 4A illustrates an embodiment of an interactive interface having one or more nodes placed on identified objects within an industrial workplace.

FIG. 4B illustrates an embodiment of an interactive interface having one or more interactive elements placed on identified objects within the industrial workplace.

FIG. 5A illustrates an embodiment of an interactive interface having one or more nodes placed on identified objects within an industrial workplace.

FIG. 5B illustrates an embodiment of an interactive interface having one or more interactive elements placed on identified objects within the industrial workplace.

FIG. 6A illustrates an embodiment of an interactive interface having one or more nodes placed on identified objects within an alternative industrial workplace.

FIG. 6B illustrates an embodiment of an interactive interface having one or more interactive elements placed on identified objects within the alternative industrial workplace.

FIG. 7 illustrates an embodiment in which a user controls one or more functional elements of an identified object.

### DETAILED DESCRIPTION

As will be described further below, different types of computer systems may be implemented to perform methods for identifying objects within images, establishing communications with those objects and, in some cases, controlling the identified objects. These computer systems may be configured to combine data collection methods with optical recognition and wireless device communication for increased safety, productivity, and user interaction. The embodiments described herein may implement a wired or wireless optical data collection hub or “link” that utilizes a precision optical recognition camera and remote data collection hardware and/or software (e.g., radio frequency identifier (RFID), iBeacon, near field communication (NFC), Bluetooth, IO Mesh, wireless local area network (WLAN), 5G cellular connections, etc.) to form a communication link that is capable of a broad range of interactivity and is widely configurable by a user.

The embodiments described herein also provide an interactive interface that allows users to view and/or interact with specific devices including industrial equipment and other devices and machines. The hardware and software implemented by the interactive interface may enable users to identify specific areas in a photo or video that the user wishes to interface with or communicate with. These areas may include machines, equipment, devices (e.g., electronic devices), people, or other objects seen in the field of view of the optical recognition camera. Once an object has been identified, the user may use the interface to apply an interactive pattern, dragging and dropping the pattern in an overlay fashion onto the object(s) identified in the image. This overlay may be sized to allow a specific area of view to become an interactive data source for the optical data collection hub to then facilitate synchronous or asynchronous communication.

From this point, a designated interactive overlay area or “zone” may be data tagged in various ways to communicate with the optical data collection hub, then becoming what will be referred to herein as a “node.” Data may then be displayed on the interactive interface on local electronic devices or on remote electronic devices including, for example, control room screens, personal computers (PCs), smart phones, tablets, etc. The interactive interface may be configured to display the photo or video, as well as apply signal processing to allow sensing, alarms, alerts, data storage, and the formation of libraries and information relevant to that specific piece of equipment, to that device, that person, or other object seen in the field of view of the optical recognition camera.

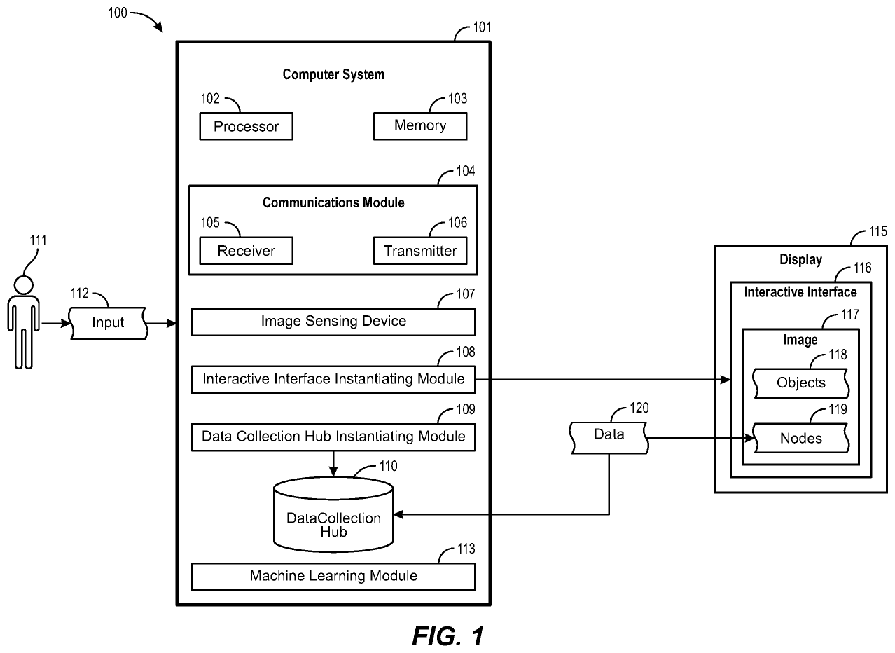

In such embodiments, the underlying system may be designed to collect data from analog or digital sensors. These sensors may communicate with embedded or other types of computer systems over wired or wireless network connections. In some cases, the sensor data may be transmitted to a server that will collect, store, and provide access to this data by those interested in using the data. The embodiments described herein may integrate camera functions to record changes of state detected by sensors to capture information visually and display it on demand to the appropriate users. Underlying software may also be configured to evaluate the nature of incoming data and may generate and send alerts to appropriate users. This integration of optical signals and alert recognition and response may provide improvements in both safety and productivity in a workplace or other environment. Such integration may also allow the reduction of time necessary to describe an area of interest, a room, or a location by uploading optical content, including photos or video streams, to immediately describe and represent the area of interest. These concepts will be described in greater detail below with regard to FIGS. 1-7.

FIG. 1 illustrates a computing environment 100 for identifying objects within images, establishing communications with those objects, and controlling the objects that were identified. FIG. 1 includes various electronic components and elements including a computer system 101 that may be used, alone or in combination with other computer systems, to perform various tasks. The computer system 101 may be substantially any type of computer system including a local computer system or a distributed (e.g., cloud) computer system. The computer system 101 may include at least one processor 102 and at least some system memory 103. The computer system 101 may include program modules for performing a variety of different functions. The program modules may be hardware-based, software-based, or may include a combination of hardware and software. Each program module may use computing hardware and/or software to perform specified functions, including those described herein below.

For example, the communications module 104 may be configured to communicate with other computer systems. The communications module 104 may include any wired or wireless communication means that can receive and/or transmit data to or from other computer systems. These communication means include hardware radios including, for example, a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, mesh network radios, or other types of receivers, transmitters, transceivers, or other hardware components configured to transmit and/or receive data. The communications module 104 may be configured to interact with databases, mobile computing devices (such as mobile phones or tablets), embedded computing systems, or other types of computing systems.

The computer system 101 also includes an image sensing device 107. The image sensing device 107 may be substantially any type of camera, charge coupled device (CCD), or other light detecting device. The image sensing device 107 may be configured to capture still images, motion pictures (e.g., video feeds), or any combination thereof. The image sensing device 107 may include a single image sensor or multiple different image sensors arrayed in a grid within a room, a workspace, or other area. The image sensing device 107 may be configured to pass still images, video clips, or a live video feed to an interactive interface 116. Indeed, the interactive interface instantiating module 108 of computer system 101 may be configured to instantiate or otherwise generate an interactive interface 116 that may display the captured images. The interactive interface 116 may be displayed on display 115, which may be local to or remote from computer system 101. The interactive interface 116 may be displayed on many different displays simultaneously.

The interactive interface 116 may include an image 117 (which may be, as noted above, a still image or a moving image of some type). That image 117 may include different objects 118 within it. These objects may be electronic devices, pieces of industrial equipment, people, or other types of objects. The interactive interface 116 may allow a user (e.g., 111) to select one or more of these objects (e.g., using input 112). The selected objects 118 then become nodes 119 that produce data 120. The data 120 may describe the object, or may describe the object's current operational status, or may provide details about the object's current tasks or schedule, or may provide other information produced by the underlying object. Thus, for instance, if the image 117 includes a video feed of a piece of industrial equipment, when the user selects that equipment, the interactive interface 116 will create a node 119 and will begin to receive data 120 from that piece of equipment. The data 120 may indicate, for example, the equipment's current operational status (e.g., operating normally (within spec), operating abnormally (out of spec), under repair, alarm status, etc.), its planned operating schedule, its maintenance schedule, its current temperature or input/output voltage level or input/output pressure level, or other information.

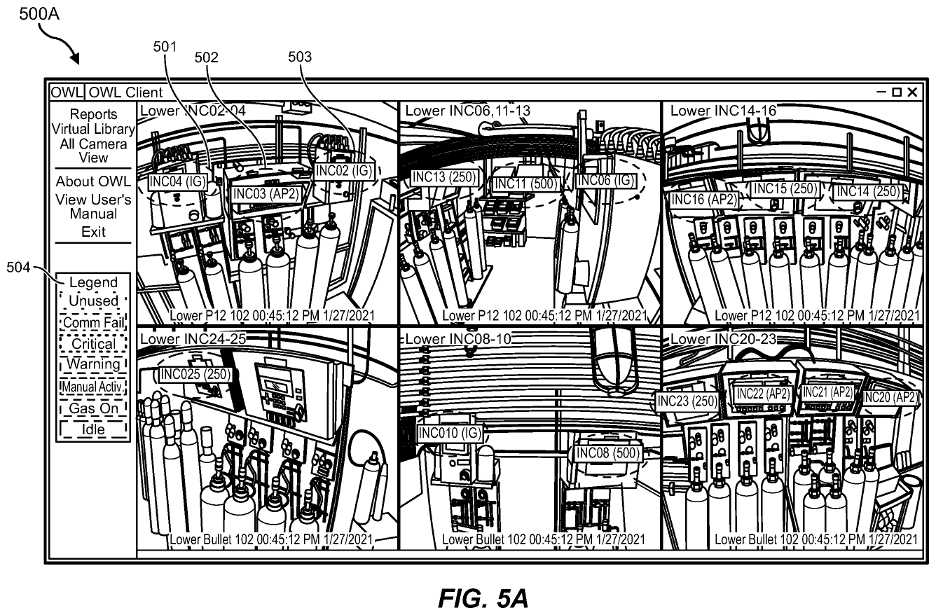

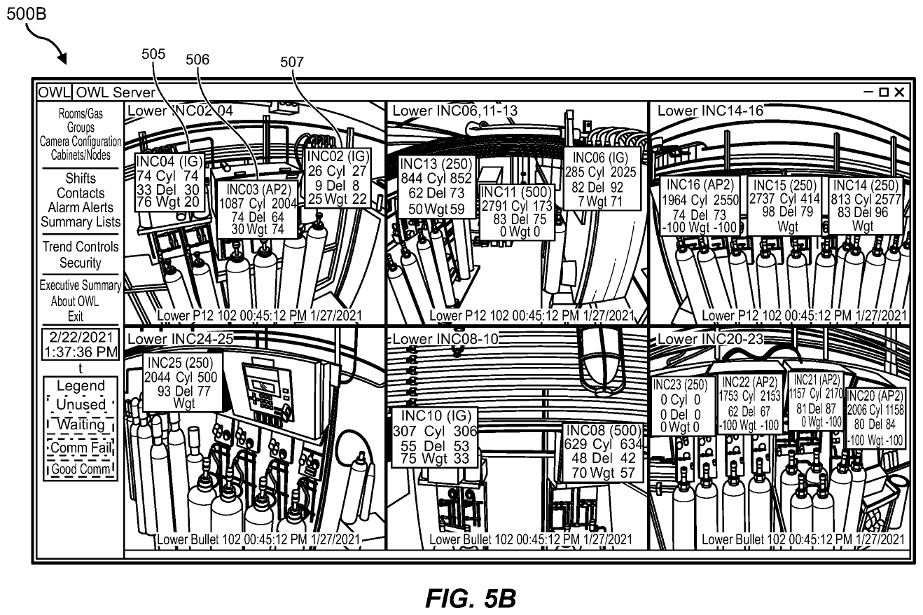

The data collection hub instantiating module 109 of computer system 101 may instantiate or otherwise provide a data collection hub 110 that is configured to gather data 120 from the various nodes 119 created by the user in the interactive interface 116. The data collection hub 110 may be substantially any type of data store or database, and may be local to computer system 101 or may be distributed (e.g., a cloud data store). The data collection hub 110 may be configured to aggregate data received from the nodes 119 representing the underlying identified objects 118 in the image 117. In some cases, the data collection hub may separately track incoming data from multiple different video feeds (as generally shown in FIG. 5A, for example). These video feeds may be implemented to track and verify that the equipment, person, or other object is performing properly. If the object is operating abnormally, the system may generate an alert so that the abnormally operating object can be attended to.

For example, in manufacturing scenarios, equipment or personnel that are visible, firsthand, typically elicit a quicker response time from safety personnel. By optically recording movements in and around manufacturing equipment, the embodiments described herein provide users the ability to track events that the nodes 119 are displaying and verify that the event is correct for each node. In one healthcare-related example, the video feed may determine that a patient in the hospital is in the wrong operating room. The patient may be identified from the image 117, or from wearable sensors. In a different example, a hazardous gas that is being installed incorrectly in a gas cabinet to supply a production tool may be identified via industrial RFID or the like. In such cases, a user using the interactive interface 116 may select the hospital patient or the hazardous gas line as nodes 119 that are to be monitored. This data 120 may then be analyzed and used to increase safety and ensure that designated protocols are followed. The embodiments herein may track an object to assure it occupies the correct space and function, and may immediately provide visual verification of correctness. This leads to increased safety when the error could cause hazards to the personnel involved.

Furthermore, most industries deal with the issue of having their workers retire and losing the knowledge that those workers have gained over their careers in the successful operation and maintenance of the facilities in which they work. This knowledge is often referred to as “tribal knowledge.” It is often learned on the job and is not written by employees. In some cases, retiring workers may take with them the best-known methods of facility maintenance, for instance. The embodiments described herein may provide a means to collect and display data at the equipment, via augmented reality or wirelessly, either when searched by the employee or presented by the underlying software in recognition of the issues presented by an alert. The embodiments herein may record personnel performing their jobs in relation to each piece of monitored equipment, thereby moving tribal knowledge from the worker to the record related to the piece of equipment. This tribal knowledge may be associated with a specific node or object, and may be stored in a data store with a tag associated the information with that node or object.

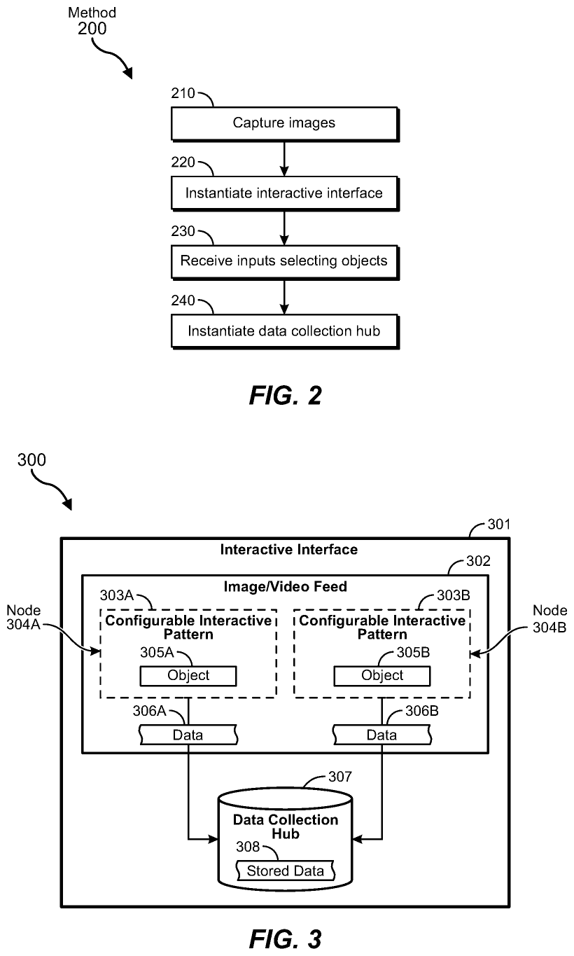

This knowledge database provides companies the ability to hire new employees and bring them rapidly up to speed with key information about the equipment, while they are at the equipment that they will be working on. The embodiments herein may implement a “virtual library” that includes work instructions, drawings, manuals, instructional videos, parts lists, and other information assigned to or associated with each piece of equipment or electronic device. When a technician arrives at a particular machine, for example, to perform service work, the machine's problems may have already been diagnosed by a person or by a software or hardware computer program. In such cases, the work instructions with required replacement parts may be made available, saving the technician time in the diagnosis of the machine's issues. Should the technician need details on the equipment in addition to what is provided, the system may access the virtual library to deliver documents and data sets to the technician via wireless or augmented reality means. These embodiments will be described further below with regard to method 200 of FIG. 2, and with regard to the embodiments depicted in FIGS. 3-7.

In view of the systems and architectures described above, methodologies that may be implemented in accordance with the disclosed subject matter will be better appreciated with reference to the flow chart of FIG. 2. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for identifying objects within images, establishing communications with those objects, and/or controlling the identified objects. The method 200 will now be described with frequent reference to the components and data of environment 100 of FIG. 1.

Method 200 generally describes a method for identifying objects within images, establishing communications with those objects, and controlling the identified objects. At step 210, the image sensing device 107 of computer system 101 of FIG. 1 may capture one or more images 117. As noted above, the images 117 may be still images, live video feeds, video clips, stored video data, or other video or still image data. In some cases, the images captured by the image sensing device 107 are stored in a local or remote data store, including potentially in the data collection hub 110.

Next, at step 220, method 200 includes instantiating an interactive interface that allows users to select objects identified in at least one of the images captured by the image sensing device. The interactive interface instantiating module 108 of computer system 101 may be configured to create, instantiate, or otherwise generate or provide access to interactive interface 116. The interactive interface 116 may display one or more still images or live video feeds. The images or videos may include various objects that are distinguishable or detectable. In some cases, object-recognition algorithms may be used to detect objects in the images.

In other cases, machine learning module 113 of computer system 101 may be used to analyze the images or videos and identify objects within them. In such cases, the machine learning module 113 may be fed many thousands or millions of images of specific objects, teaching the underlying machine learning algorithms how to identify people (or specific persons), pieces of industrial equipment, electrical devices, analog or digital displays affixed to machines or equipment, or other types of objects. After learning what a given person looks like, or what a specific machine looks like, or what a specific display looks like, the machine learning algorithms may analyze an image 117, determine that there are identifiable objects within the image, and determine what those objects are (persons, devices, equipment, etc.). In some cases, the machine learning may be taught to determine which model of a piece of equipment or electrical device has been identified in the image 117.

The communications module 104 of computer system 101 may then, at step 230 of method 200, receive user inputs 112 that select at least one identified object within the image 117. This selection creates a corresponding node that provides data related to the identified object. In some embodiments, the user 111 may provide inputs 112 (e.g., mouse and keyboard inputs, touch inputs, speech inputs, gestures, or other detectable inputs) that select an identified object 118 within the image 117. Although each image may include many different objects 118, the object selected by the user 111 becomes a node 119. This node is then capable of providing data 120 about the underlying, selected object 118.

If the selected object 118 is a person, the node 119 may provide data 120 about that person including potentially their name, title, role, time on the job that day, experience level, an indication of tasks that person is qualified to perform, clearance levels associated with that user, etc. If the selected object 118 is a gas cabinet, as another example, the node 119 may report the type of gas cabinet, current inputs and outputs, current pressure levels, current operational status, types of gas being used, etc. As will be understood, each node 119 may have its own specific data 120. This data 120 may be received and aggregated, at step 240 of method 200, at a data collection hub 110. The data collection hub 110 may be configured to receive and aggregate data received from many different nodes 119 created by the user 112 through the interactive interface 116, including nodes from a single image or from multiple different images.

In some cases, the interactive interface may allow users to overlay configurable interactive patterns over the identified objects in images. For instance, the configurable interactive patterns may be dragged and dropped or otherwise positioned onto the identified objects, such that the configurable interactive patterns are overlaid on top of the identified objects. For example, as shown in embodiment 300 of FIG. 3, an interactive interface 301 may allow a user to drag and drop configurable interactive pattern 303A onto object 305A. Once the object 305A has been selected, and/or when the configurable interactive pattern 303A has been applied to object 305A, the interactive interface 301 creates a node 304A for object 305A. A similar node 304B may be created when the user applies a configurable interactive pattern 303B to object 305B. The respective nodes 304A and 304B may provide data 306A/306B to a data collection hub 307, where the data 308 may be stored for future access.

The configurable interactive patterns 303A/303B overlaid on top of the identified objects 305A/305B may allow users to receive data from the identified objects and, at least in some cases, transmit data to the identified objects. The configurable interactive pattern 303A/303B may be any type of user interface element that represents an underlying data connection to an object. For instance, when a user applies a configurable interactive pattern to an object (e.g., 305A), the interactive interface 301 attempts to initiate communication with the object (or a device or interface associated with the object). In cases where the object 305A is an electronic device such as a smartphone or tablet, the interactive interface 301 may initiate wireless communication (e.g., Bluetooth, WiFi, cellular, etc.) with the device.

In cases where the object 305A is a piece of industrial equipment, the interactive interface 301 may initiate communication with that equipment (or with sensors associated with the equipment). The equipment may provide analog or digital data, or may provide sensor data that is transmittable to the interactive interface 301. This data 306A may then be aggregated and stored at the data collection hub 307, and may be associated with that object. In some cases, the industrial equipment may include analog dials or gauges, or digital readouts, light emitting diode (LED) displays, or similar status indicators. In such cases, the images or video feed 302 may be analyzed by machine learning algorithms or by object recognition system to identify the data on the dials or gauges and convert that data for display within the interactive interface 301 and/or for storage within the data collection hub. Thus, communication with the objects identified in the images or video feed 302 may be direct (e.g., device-to-device communication over a wired or wireless network), or may be indirect, with video images being analyzed to determine what is being communicated by each of the identified objects. This may be especially true for older industrial equipment that is does not include network communication capabilities, but nevertheless provides sensor information, operational status information, and other details on analog dials, gauges, or LED readouts. The interactive interface 301 may provide an easy-to-use system that allows a user to simply select an identified object in an image or video feed, and the underlying system will identify the best way to communicate with or gather information from that object and present it to the user.

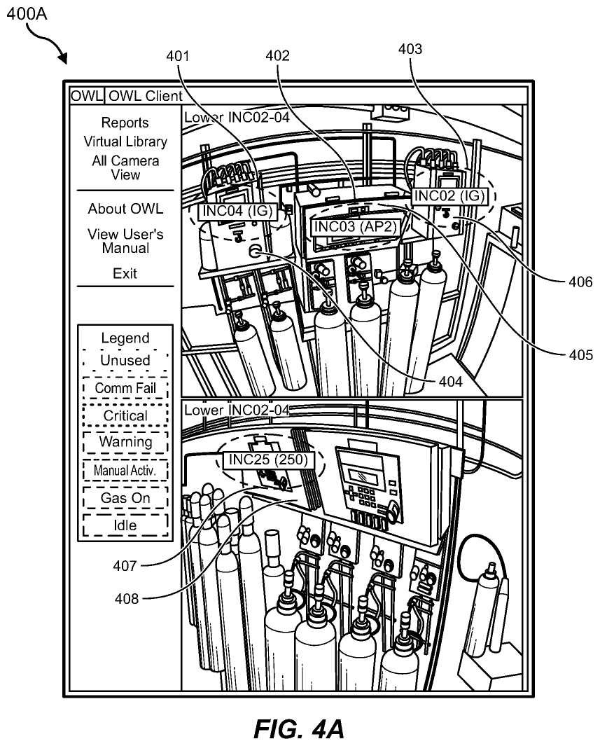

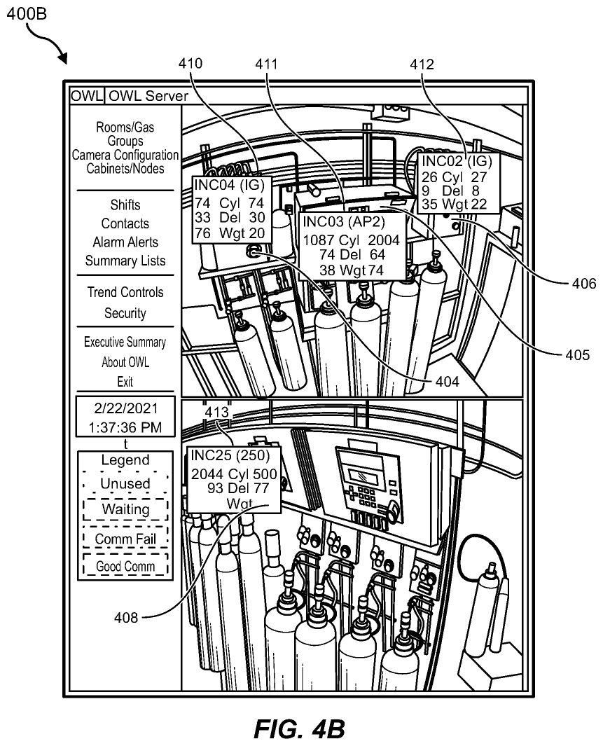

FIGS. 4A and 4B illustrate examples of configurable interactive patterns that may be placed on identified objects. For instance, FIG. 4A illustrates an embodiment 400A with two camera feeds showing different industrial environments. Each camera feed in FIG. 4A includes gas canisters as well as gas regulators or gas cabinets (e.g., 404, 405, 406, and 408). Each of these may be identified as objects by the interactive interface (e.g., 116 of FIG. 1) or by the machine learning module 113 of FIG. 1. Each identified object in FIG. 4A may have an associated configurable interactive pattern placed thereon with an identifier. For example, identified object 404 may have a configurable interactive pattern 401 within the identifier INC04 (IG). Similarly, identified object 405 may have a configurable interactive pattern 402 with identifier INC03 (AP2), identified object 406 may have a configurable interactive pattern 403 with identifier INC02 (IG), and identified object 408 in the lower video feed may have a configurable interactive pattern 407 with identifier INC25 (250). These identifiers may identify the underlying hardware equipment and/or may specify other details about the identified object.

FIG. 4B illustrates the same two upper and lower video feeds in embodiment 400B, but in this figure, each of the configurable interactive patterns is now showing data related to the underlying identified objects. Thus, identified object 404 now has an updated configurable interactive pattern 410 showing information about the operational status of the equipment 404, or showing other information as configured by a user. Indeed, each configurable interactive pattern may be configured by a user (e.g., 111 of FIG. 1) to show different types of data. Each configurable interactive pattern may be specific to each type of device or to each identified object. As such, users may be able to look at a video feed and have a specified set of data displayed for each different type of identified object. Updated configurable interactive pattern 411 may show data being output by object 405, updated configurable interactive pattern 412 may show data output by object 406, and updated configurable interactive pattern 413 may show data output by object 408.

In some embodiments, an image sensing device (e.g., 107 of FIG. 1) may be positioned to capture a specific workspace. For example, as shown in FIGS. 5A and 5B, a plurality of image sensing devices may be positioned at different locations in a workspace to capture the operations occurring in those rooms and potentially the comings and goings of specific users including workers. In the embodiments 500A and 500B of FIGS. 5A and 5B, the objects identified in the images of the workspace may include industrial equipment that is to be monitored. Additionally or alternatively, the identified objects in the images or respective video feeds may include electronic devices, pieces of machinery, pieces of equipment, people, sensors, or other objects. A user may be able to apply configurable interactive patterns to any or all of the identified objects. These configurable interactive patterns may include user interface display elements that display data related to the identified objects.

Thus, in some cases, the identified objects in each video feed may be assigned visual elements 501, 502, 503, and others not individually referenced. As shown in FIG. 5B, each of those visual elements may change to show data 505, 506, or 507 related to the identified objects. In some cases, the visual elements may include words, colors, alerts, or other indicia of status. For instance, as shown in the legend 504 of FIG. 5A, a color scheme may show that a given identified object is currently unused, or has had a communications failure, or is in critical condition, or is currently issuing a warning, is currently idle, etc. Thus, at glance, a user may be able to be informed of the status of each of the identified objects in a video feed.

In some cases, the visual display elements 501-503, or 505-507 may be displayed on different computer systems that are remote from the workspace that is being monitored. For instance, a user may be monitoring a given space remotely from their tablet or smartphone. The user's tablet or smartphone may display an interactive interface (e.g., 116 of FIG. 1) that shows the visual display elements in a format or manner of presentation that allows the user to see, for each workspace, how the equipment or devices in that workspace are operating. At any time, the user may initiate a new analysis for identified objects, and may apply configurable interactive patterns to any newly identified objects in the workspace. Or, the user, through the interactive interface 116, may update or reconfigure any existing configurable interactive patterns to show new types of information for each device or other identified object. Thus, the user's display may be customizable and fully updateable over time.

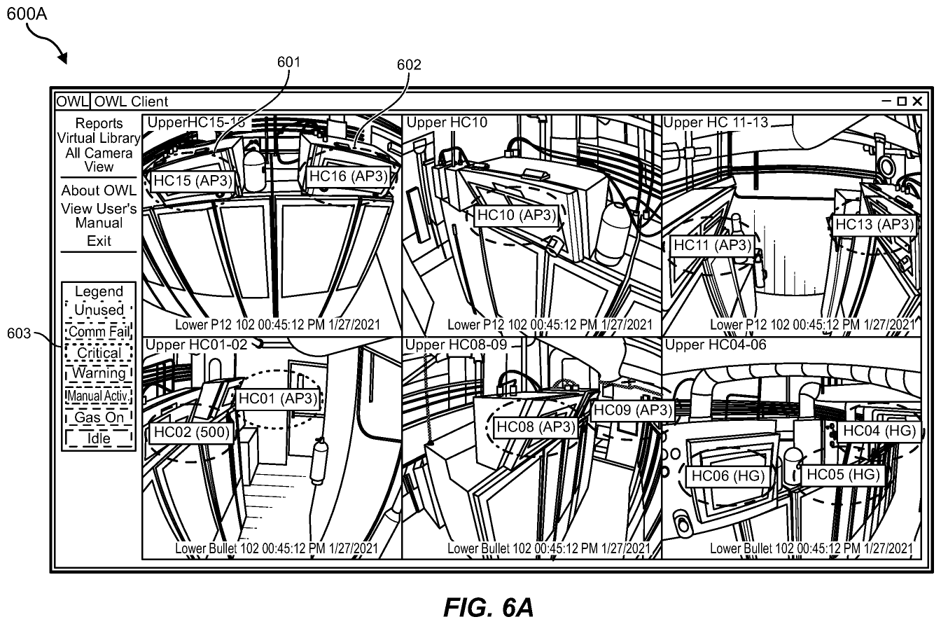

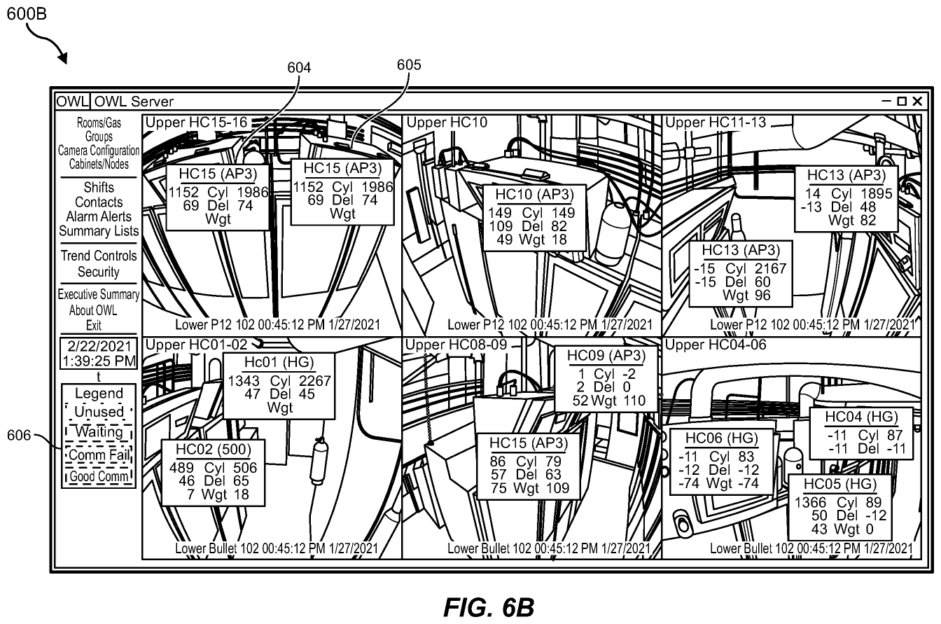

FIGS. 6A and 6B illustrate an alternative environment in which devices are monitored through the application of configurable interactive patterns to different identified objects. In some cases, the data collection hub 110 of FIG. 1 may be configured to monitor for changes in state in equipment under surveillance by different image sensing devices. In environment 600A of FIG. 6A, six different video feeds are shown, allowing a user to monitor for state changes in equipment under surveillance including devices 601 and 602, along with other devices shown in other video feeds. Each identified device may have an individual identifier, and each may have a unique configurable interactive pattern applied to it to display different types of data. In some cases, that data will be overlaid on the video feed according to color or data schemes specified in a corresponding legend 603. In some embodiments, the legend 606 may itself change in different views of the interactive interface (e.g., in environment 600B of FIG. 6B) that shows the various video feeds and the corresponding visual elements 604 and 605 that display the requested data for each identified object. The data from each identified object may be received and aggregated at the data collection hub 110.

In some cases, that received data may be presented in a control room monitoring device such as a tablet, smartphone, or other type of display. The control room monitoring device may be configured to display alerts or notifications generated by the identified objects. In some cases, alerts or notifications may be directed to specific individuals or entities. Specifically, some changes in the data received from one or more identified objects may indicate that a piece of equipment is operating abnormally. In such cases, the interactive interface or the control room monitoring device may generate and display an alert for that specific user upon determining that a specified change in state has occurred. In some embodiments, machine learning may be used to determine when a device or other identified object is operating abnormally. Over time, machine learning algorithms may access and analyze data output by the identified objects. The machine learning algorithms may identify usage patterns for the device and may determine what is normal operation and what is abnormal. In such cases, if the machine learning algorithm determines that the device or other object is operating abnormally, the computer system may generate an alert that is displayed over the specific device or object that is operating abnormally, and/or may be sent to specific users and displayed in the interactive interface to inform any monitoring users about the device's abnormal operation.

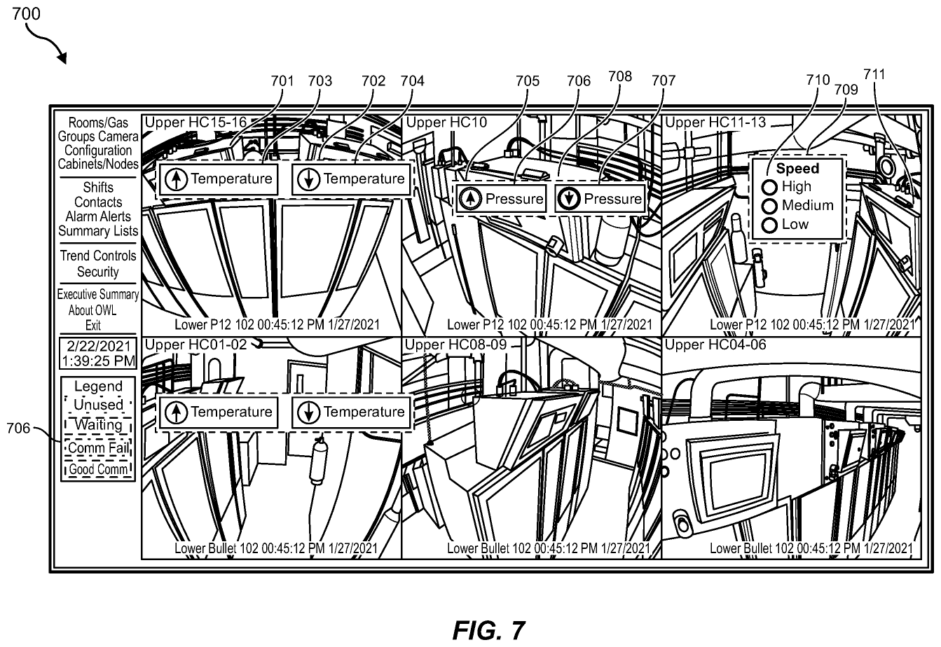

In some cases, as noted above, the interactive interface may provide configurable interactive patterns that are overlaid on top of the identified objects in the images. In some embodiments, the configurable interactive patterns overlaid on top of the identified objects may allow real-time interaction with the identified objects. This real-time interaction may include users issuing commands to the identified objects. These commands are then interpreted and carried out by the identified objects. For instance, as shown in FIG. 7, a piece of industrial equipment 701 may display a configurable interactive pattern 702 overlaid over the equipment. The configurable interactive patterns 702 may include a control for “temperature,” indicating that the user may use buttons 703 and 704 to increase or decrease the temperature at which the industrial equipment is operating. Of course, different objects and even different types of industrial equipment will have different controls for different options. Some will not allow temperature regulation, but may allow pressure regulation, or speed regulation, or power regulation, etc. Thus, configurable interactive pattern 705 may include buttons 706 and 707 that allow a user to increase or decrease pressure on the equipment 708, and configurable interactive pattern 709 may include buttons 710 that allow a user to increase or decrease operational speed of the equipment 711.

It will be understood that, in the above examples, speed, pressure, and temperature are merely three of many different scenarios in which different aspects of an object may be controlled. Moreover, the controls need not merely be up or down, but may include dials or entry fields to select specific levels of an operational parameter, or may include other types of input buttons or fields that allow users to input custom commands to the equipment or other objects. The interactive interface may then be configured to communicate the commands to the underlying objects. This communication may include communicating directly with the object over a wired or wireless connection, communicating with a human user who can enter the commands manually into the equipment or device, or communication with an internal or external controller that can change operational parameters of the equipment.

In some cases, the configurable interactive patterns may be configured to be dynamically changeable to show different available commands that are specific to each identified object. Thus, the interactive interface 116 may communicate with the identified object, determine its operational characteristics and what it is capable of doing, determine which commands may be received and carried out by the object, and then present those operational commands or parameters in the overlaid configurable interactive patterns. Then, a user may simply view the configurable interactive patterns to know which commands are available for each identified object, and may issue one or more of those commands via a control signal to the object. Those issued commands may then specify changes of state or changes in operational parameters or specified tasks that are to be carried out on the identified objects.

In this manner, the embodiments described herein provide software that enables users to identify specific areas of view from a camera (photo or video) that the user wishes to interact or communicate with. Once an object is identified, the user may place a configurable interactive pattern in an overlay fashion onto the object and may begin interacting with that object. This area recognition capability allows this camera view to become an interactive zone on the screen where the identified object becomes a data source that can be collected and viewed and further allows the software to begin communication.

The overlay may convert the chosen area of the image or video feed to a data node or interactive zone. The data node created by the end-user may be data tagged in various ways to communicate with the server. Data nodes may be displayed on other remote devices such as control room screens, computers, smart phones, or other electronic devices that are capable of visually displaying the tagged area signals. This allows sensing, alarms, alerts, storage of data, and the formation of libraries and information relevant to that specific equipment, device, person, or other object seen in the field of view from the camera.

The embodiments described herein may collect data from sensors, equipment, people, and other data sources that may be configured to communicate via Ethernet, analog, or discrete means. Backend servers may be configured to collect, store, timestamp, and monitor interactions, changes in state, and other events. This may allow analyzation and comprehensive communication between the end-user and anything they wish to monitor or control. In some cases, the collected data may be processed via data analytics systems including machine learning systems and artificial intelligence (AI) systems. The machine learning may be configured to learn and identify patterns in the data, including patterns that indicate whether the device is operating normally or abnormally or whether safety protocols are being adhered to within a workplace environment. The machine learning algorithms may analyze and learn from images and video feeds showing correct adherence to protocols (e.g., maintenance upgrades) or normal equipment operation. These images and video feeds may be stored in historical data accessible to the machine learning algorithms. Then, upon analyzing subsequent images and video feeds, the machine learning algorithms or AI may identify discrepancies and may generate alerts accordingly.

The embodiments herein integrate camera functions to record changes of state from existing sensors, even analog devices, to capture information visually then display it on demand to the appropriate users. The interactive interface may evaluate the nature of incoming alerts to provide an appropriate response to the user. This integration of optical signals and alarm/alert notification and response allows improvements in both safety and productivity, reducing the time needed to describe an area of interest, a room, or a location by uploading optical content, namely photo or video, to immediately describe and represent areas of concern. In some case, technicians may implement a virtual reality or augmented reality headset when performing tasks. These headsets may record the user's actions. These actions may then be stored in a virtual library or knowledge database that can be later accessed by new employees to learn how to properly perform a given task. This knowledge databased may be tagged with searchable tags that allow users to search for and find task instructions, drawings, manuals, instructional videos, parts lists, and other information used in the course of their job. When the technician arrives at the equipment to perform service work, the equipment's issue may be diagnosed using the virtual library's stored work instructions along with required replacement parts. This may save the technician a great deal of time, not having to learn a task from scratch. Moreover, any newly added video or written data may be stored in the virtual library for use by other workers.

It will be further understood that the embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

Computing systems typically include at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory”, and includes memory locations that are addressable by the at least one processing unit over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A system, comprising:
an image sensing device configured to capture images;
a transceiver;
an interactive interface that allows a user to select one or more objects identified in at least one of the images captured by the image sensing device, wherein selecting an identified object within the images creates a corresponding node that provides data related to the identified object; and
a data collection hub configured to receive and aggregate data received from one or more of the nodes created by the user through the interactive interface.

2. The system of claim 1, wherein the interactive interface allows users to overlay one or more configurable interactive patterns over the identified objects in the images.

3. The system of claim 2, wherein the configurable interactive patterns are dragged and dropped onto the identified objects, such that the configurable interactive patterns are overlaid on top of the identified objects.

4. The system of claim 3, wherein the configurable interactive patterns overlaid on top of the identified objects allow users to receive data from the identified objects and transmit data to the identified objects.

5. The system of claim 4, wherein the data includes current status data for the identified objects.

6. The system of claim 3, wherein the configurable interactive patterns overlaid on top of the identified objects allow real-time interaction with the identified objects.

7. The system of claim 3, wherein the identified objects in the images comprise at least one of electronic devices, pieces of machinery, pieces of equipment, people, or sensors.

8. The system of claim 1, wherein the data received at the data collection hub is presented in a control room monitoring device.

9. The system of claim 1, wherein the image sensing device is positioned to capture a specific workspace, and wherein the objects identified in the images of the workspace comprise equipment that is to be monitored.

10. The system of claim 1, wherein the interactive interface includes one or more user interface display elements that display the data related to the identified object.

11. The system of claim 10, wherein the user interface display elements are displayed on one or more computer systems that are remote from a workspace that is being monitored.

12. A computer-implemented method comprising:
capturing one or more images using an image sensing device;
instantiating an interactive interface that allows a user to select one or more objects identified in at least one of the images captured by the image sensing device;
receiving one or more user inputs that select an identified object within the images, wherein the selection creates a corresponding node that provides data related to the identified object; and
instantiating a data collection hub configured to receive and aggregate data received from one or more of the nodes created by the user through the interactive interface.

13. The computer-implemented method of claim 12, wherein the data collection hub is further configured to monitor for changes in state in equipment under surveillance by the image sensing device.

14. The computer-implemented method of claim 13, further comprising generating one or more alerts or notifications directed to specific individuals upon determining that a specified change in state has occurred.

15. The computer-implemented method of claim 12, wherein the aggregated data received from the one or more nodes created by the user is further analyzed by one or more machine learning algorithms to identify when the identified object is functioning abnormally.

16. The computer-implemented method of claim 12, wherein one or more machine learning algorithms are implemented to identify one or more of the objects in the images captured by the image sensing device.

17. The computer-implemented method of claim 12, wherein the interactive interface provides configurable interactive patterns that are overlaid on top of one or more of the identified objects in the images.

18. The computer-implemented method of claim 17, wherein the configurable interactive patterns allow users to issue commands to the identified objects that are interpreted and carried out by the identified objects.

19. The computer-implemented method of claim 18, wherein the issued commands specify one or more changes of state that are to be effected on the identified objects.

20. A non-transitory computer-readable medium comprising one or more computer-executable instructions that, when executed by at least one processor of a computing device, cause the computing device to:
capture one or more images using an image sensing device;
instantiate an interactive interface that allows a user to select one or more objects identified in at least one of the images captured by the image sensing device;
receive one or more user inputs that select an identified object within the images, wherein the selection creates a corresponding node that provides data related to the identified object; and
instantiate a data collection hub configured to receive and aggregate data received from one or more of the nodes created by the user through the interactive interface.
